(19) United States
(12) Patent Application Publication
(10) Pub. No.: US 2018/0314069 A1
(43) Pub. Date: Nov. 1, 2018

(54) Head Mounted Display Device And Control Method Thereof

(71) Applicant: Acer Incorporated, New Taipei City (TW)

(72) Inventors: Yu-Chun HUANG, New Taipei City (TW); Chih-Cheng CHEN, New Taipei City (TW)

(21) Appl. No.: 15/828,657

(22) Filed: Dec. 1, 2017

(30) Foreign Application Priority Data
Apr. 28, 2017 (TW) 106114260

(51) Int. Cl. G02B 27/01; G01C 21/16

(52) U.S. Cl. CPC G02B 27/0179; G02B 2027/0187; G02B 2027/014; G01C 21/165

(57) ABSTRACT

A head mounted display (HMD) device includes a clock generator, a positioning system, and an inertial measurement unit (IMU). The clock generator is configured to generate a clock signal. The positioning system is configured to detect coordinate information of the user. The IMU is configured to detect rotation angle information of the user. The positioning system and the IMU add a timestamp to the coordinate information and the rotation angle information according to the clock signal.

### CROSS REFERENCE TO RELATED APPLICATIONS

This Application claims priority of Taiwan Patent Application No. 106114260 filed on Apr. 28, 2017, the entirety of which is incorporated by reference herein.

### BACKGROUND OF THE INVENTION

### Field of the Invention

The disclosure generally relates to a head-mounted display (HMD) device, and more particularly, to a head-mounted display device with high-accuracy detection.

### Description of the Related Art

Virtual reality (VR) uses a computer simulation to generate a three-dimensional (3D) virtual world, and it can provide a visual sensory simulation for a user, such that the user perceives an immersive environment. When the user moves, the computer can immediately perform a complex calculation and return an accurate image of the 3D world, and therefore the user senses the presence of the 3D world.

However, because the current technique for positioning and rotating detections is not accurate, the virtual reality often makes the user dizzy. Accordingly, there is a need to propose a novel design for overcoming this problem of the prior art.

### BRIEF SUMMARY OF THE INVENTION

In an exemplary embodiment, the disclosure is directed to a head mounted display (HMD) device including a clock generator, a positioning system, and an inertial measurement unit (IMU). The clock generator is configured to generate a clock signal. The positioning system is configured to detect coordinate information of the user. The IMU is configured to detect rotation angle information of the user. The positioning system and the IMU add a timestamp to the coordinate information and the rotation angle information according to the clock signal.

In some embodiments, the coordinate information and the rotation angle information are transmitted to a computing device.

In some embodiments, the computing device uses an extended Kalman filter (EKF) to process the coordinate information and the rotation angle information.

In some embodiments, the computing device generates virtual reality (VR) image information according to the coordinate information and the rotation angle information which have the same timestamp.

In another exemplary embodiment, the invention is directed to a control method for a head-mounted display (HMD) device. The control method includes the steps of: generating a clock signal; detecting coordinate information of a user; detecting rotation angle information of the user; and adding a timestamp to the coordinate information and the rotation angle information according to the clock signal.

In some embodiments, the control method further includes: transmitting the coordinate information and the rotation angle information to a computing device.

In some embodiments, the control method further includes: using an extended Kalman filter (EKF) to process the coordinate information and the rotation angle information.

In some embodiments, the control method further includes: generating virtual reality (VR) image information according to the coordinate information and the rotation angle information which have the same timestamp.

In an exemplary embodiment, the invention is directed to a non-transitory computer-readable medium storing a computer program product operable to cause a head-mounted display (HMD) device to perform operations including: generating a clock signal; detecting coordinate information of a user; detecting rotation angle information of the user; and adding a timestamp to the coordinate information and the rotation angle information according to the clock signal.

### BRIEF DESCRIPTION OF DRAWINGS

The invention can be more fully understood by reading the subsequent detailed description and examples with references made to the accompanying drawings, wherein:

FIG. 1 is a diagram of a head-mounted display device according to an embodiment of the invention;

FIG. 2 is a diagram of the relationship between coordinate information and timestamps according to an embodiment of the invention;

FIG. 3 is a diagram of the relationship between rotation angle information and timestamps according to an embodiment of the invention;

FIG. 4 is a perspective view of a head-mounted display device and a computing device according to an embodiment of the invention;

FIG. 5 is a flowchart of a control method for a head-mounted display device according to an embodiment of the invention; and

FIG. 6 is a flowchart of a control method for a head-mounted display device according to another embodiment of the invention.

### DETAILED DESCRIPTION OF THE INVENTION

In order to illustrate the purposes, features and advantages of the invention, the embodiments and figures of the invention are shown in detail as follows.

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. The term “substantially” means the value is within an acceptable error range. One skilled in the art can solve the technical problem within a predetermined error range and achieve the proposed technical performance. Also, the term “couple” is intended to mean either an indirect or direct electrical connection. Accordingly, if one device is coupled to another device, that connection may be through a direct electrical connection, or through an indirect electrical connection via other devices and connections.

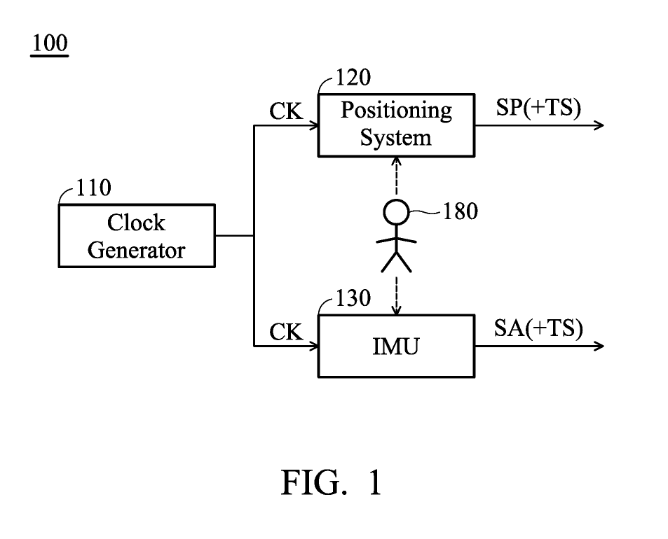

FIG. 1 is a diagram of a head-mounted display (HMD) device 100 according to an embodiment of the invention. The head-mounted display device 100 can be applied to a virtual reality (VR) technique. A user 180 can wear the head-mounted display device 100. As shown in FIG. 1, the head-mounted display device 100 includes a clock generator 110, a positioning system 120, and an inertial measurement unit (IMU) 130. The clock generator 110 may be a square wave generator, and it is arranged for generating a clock signal CK. For example, the frequency of the clock signal CK may be 0.9 kHz, 1 kHz, or 2 kHz. The positioning system 120 may be a motion capture system, and it is arranged for detecting coordinate information SP of the user 180. For example, the coordinate information SP may include an X-axis coordinate, a Y-axis coordinate, and a Z-axis coordinate of the user 180. The IMU 130 may be an accelerometer (G-sensor), a magnetometer (M-sensor), or a gyroscope, and it is arranged for detecting rotation angle information SA of the user 180. For example, the rotation angle information SA may include a zenith angle (theta) rotation and an azimuth angle (phi) rotation of the user 180. Both the positioning system 120 and the IMU 130 can add a timestamp TS to the coordinate information SP and the rotation angle information SA according to the clock signal CK. The timestamp TS can indicate a corresponding time point of each of the coordinate information SP and the rotation angle information SA. It should be noted that the head-mounted display device 100 may further include other components, such as a display device, an upper cover, a front cover, a left-side cover, a right-side cover, and a plurality of light-emitting diodes (LEDs) although they are not displayed in FIG. 1.

In some embodiments, each of the positioning system 120 and the IMU 130 further includes a counter. By counting the number of the received rising edges or the received falling edges of the clock signal CK, the positioning system 120 and the IMU 130 can obtain different time points and therefore establish the relationship between the timestamp TS and each of the coordinate information SP and the rotation angle information SA.

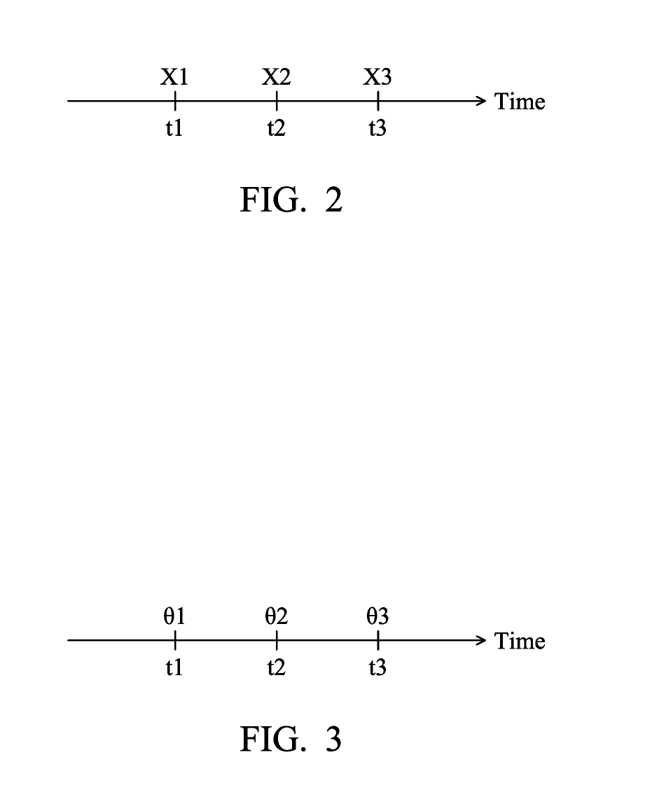

FIG. 2 is a diagram of the relationship between the coordinate information SP and the timestamps TS according to an embodiment of the invention. In the embodiment of FIG. 2, the coordinate information SP includes a first coordinate datum X1, a second coordinate datum X2, and a third coordinate datum X3 of the user 180. The first coordinate datum X1 is measured at a first time point t1. The second coordinate datum X2 is measured at a second time point t2. The third coordinate datum X3 is measured at a third time point t3. Each of the first coordinate datum X1, the second coordinate datum X2, and the third coordinate datum X3 may include an X-axis coordinate, a Y-axis coordinate, and a Z-axis coordinate of the user 180. The aforementioned operation of adding the timestamp TS to the coordinate information SP may mean that in this embodiment, the information of the first time point t1 is added to the first coordinate datum X1, the information of the second time point t2 is added to the second coordinate datum X2, and the information of the third time point t3 is added to the third coordinate datum X3. After the positioning system 120 processes the coordinate information SP according to the clock signal CK, each coordinate datum is correlated with a corresponding time point. Therefore, the subsequent computing device can easily use the coordinate information SP of the user 180.

FIG. 3 is a diagram of the relationship between the rotation angle information SA and the timestamps TS according to an embodiment of the invention. In the embodiment of FIG. 3, the rotation angle information SA includes a first rotation angle θ1, a second rotation angle θ2, and a third rotation angle θ3 of the user 180. The first rotation angle θ1 is measured at a first time point t1. The second rotation angle θ2 is measured at a second time point t2. The third rotation angle θ3 is measured at a third time point t3. Each of the first rotation angle θ1, the second rotation angle θ2, and the third rotation angle θ3 may include a zenith angle rotation and an azimuth angle rotation of the user 180. The aforementioned operation of adding the timestamp TS to the rotation angle information SA may mean that in this embodiment, the information of the first time point t1 is added to the first rotation angle θ1, the information of the second time point t2 is added to the second rotation angle θ2, and the information of the third time point t3 is added to the third rotation angle θ3. After the IMU 130 processes the rotation angle information SA according to the clock signal CK, each rotation angle is correlated with a corresponding time point. Therefore, the subsequent computing device can easily use the rotation angle information SA of the user 180.

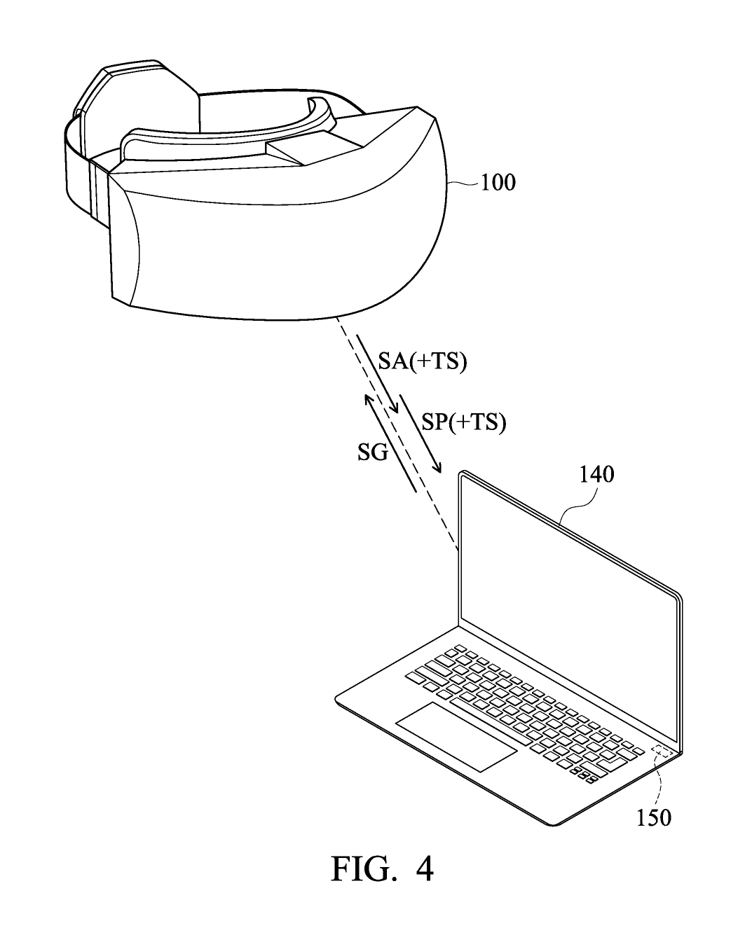

FIG. 4 is a perspective view of the head-mounted display device 100 and a computing device 140 according to an embodiment of the invention. In the embodiment of FIG. 4, the coordinate information SP and the rotation angle information SA, which have been correlated with the timestamps TS, are further transmitted to the computing device 140. A virtual reality (VR) system may be formed by the head-mounted display device 100 and the computing device 140. For example, the computing device 140 may be a smart phone, a tablet computer, or a notebook computer. The computing device 140 can use an extended Kalman filter (EKF) 150 to process the coordinate information SP and the rotation angle information SA. The EKF 150 may be implemented with a hardware logic circuit or a software computer program. Specifically, the computing device 140 can generate VR image information SG according to the coordinate information SP and the rotation angle information SA which have the same timestamp TS. The VR image information SG may be transmitted back to the head-mounted display device 100 for display, such that the user 180 senses an immersive environment.

Please refer to the embodiments of FIG. 2, FIG. 3, and FIG. 4. According to the timestamps TS, the first coordinate datum X1 and the first rotation angle θ1 which are both measured at the same first time point t1 can be processed together by the computing device 140; the second coordinate datum X2 and the second rotation angle θ2 which are both measured at the same second time point t2 can be processed together by the computing device 140; and the third coordinate datum X3 and the third rotation angle θ3 which are both measured at the same third time point t3 can be processed together by the computing device 140. Since the timestamps TS indicate accurate time points, the computing device 140 can easily find the corresponding relationship between all coordinate data and all rotation angles, so as to accurately estimate the real movement and rotation state of the user 180.

For a conventional design, because the coordinate information SP and the rotation angle information SA do not include any timestamp TS, the subsequent computing device 140 may face the problem of mixing up the coordinate information SP with the rotation angle information SA. For example, the second coordinate datum X2 may incorrectly correspond to the third rotation angle θ3. Thus, the computing device 140 may generate VR image information SG whose movement or rotation is incorrect, and the user 180 may feel dizzy. To solve the aforementioned problem, the invention proposes a novel design which adds the timestamp TS to the coordinate information SP and the rotation angle information SA according to the clock signal CK. The proposed design can simplify the procedure in which the computing device 140 processes the coordinate information SP and the rotation angle information SA, and it helps to increase the whole fidelity of the VR system and prevent the user 180 from being uncomfortable when wearing the head-mounted display device 100.

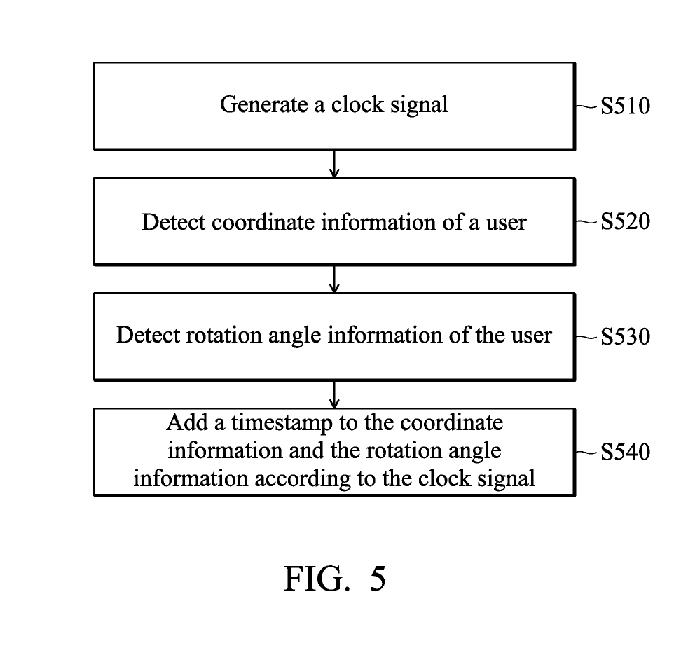

FIG. 5 is a flowchart of a control method for a head-mounted display device according to an embodiment of the invention. To begin, in step S510, a clock signal is generated by a clock generator. In step S520, coordinate information of a user is detected by a positioning system. In step S530, rotation angle information of the user is detected by an inertial measurement unit (IMU). Finally, in step S540, a timestamp is added to the coordinate information and the rotation angle information by the positioning system and the IMU according to the clock signal.

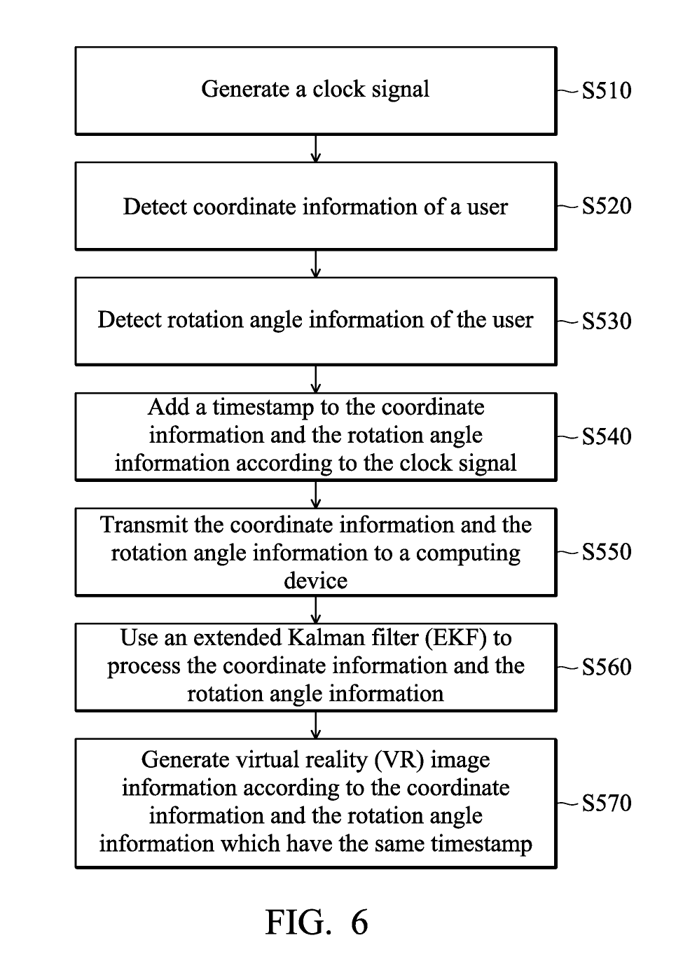

FIG. 6 is a flowchart of a control method for a head-mounted display device according to another embodiment of the invention. FIG. 6 is similar to FIG. 5, but the embodiment of FIG. 6 further includes the following steps. In step S550, the coordinate information and the rotation angle information are transmitted to a computing device. In step S560, an extended Kalman filter (EKF) is used by the computing device to process the coordinate information and the rotation angle information. In step S570, virtual reality (VR) image information is generated by the computing device according to the coordinate information and the rotation angle information which have the same timestamp.

It should be noted that it is not required that the steps of FIG. 5 and FIG. 6 be performed sequentially, and each feature of the embodiments of FIGS. 1 to 4 may be applied to the control methods of FIG. 5 and FIG. 6.

The method of the invention, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

Note that the above element parameters and clock frequencies are not limitations of the invention. A designer can fine-tune these settings or values according to different requirements. It should be understood that the head-mounted display device, the control method, and the non-transitory computer-readable medium of the invention are not limited to the configurations of FIGS. 1-6. The invention may merely include any one or more features of any one or more embodiments of FIGS. 1-6. In other words, not all of the features displayed in the figures should be implemented in the head-mounted display device, the control method, and the non-transitory computer-readable medium.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

1. A head-mounted display (HMD) device, comprising:
a clock generator, generating a clock signal;
a positioning system, detecting coordinate information of a user; and
an inertial measurement unit (IMU), detecting rotation angle information of the user;
wherein the positioning system and the IMU add a timestamp to the coordinate information and the rotation angle information according to the clock signal;
wherein the coordinate information comprises an X-axis coordinate, a Y-axis coordinate, and a Z-axis coordinate of the user, and wherein the rotation angle information comprises a zenith angle rotation and an azimuth angle rotation of the user.

2. The head-mounted display device as claimed in claim 1, wherein the coordinate information and the rotation angle information are transmitted to a computing device.

3. The head-mounted display device as claimed in claim 2, wherein the computing device uses an extended Kalman filter (EKF) to process the coordinate information and the rotation angle information.

4. The head-mounted display device as claimed in claim 3, wherein the computing device generates virtual reality (VR) image information according to the coordinate information and the rotation angle information which have the same timestamp.

5. A control method for a head-mounted display (HMD) device, comprising the steps of:
generating a clock signal;
detecting coordinate information of a user;
detecting rotation angle information of the user; and
adding a timestamp to the coordinate information and the rotation angle information according to the clock signal;
wherein the coordinate information comprises an X-axis coordinate, a Y-axis coordinate, and a Z-axis coordinate of the user, and wherein the rotation angle information comprises a zenith angle rotation and an azimuth angle rotation of the user.

6. The control method as claimed in claim 5, further comprising:
transmitting the coordinate information and the rotation angle information to a computing device.

7. The control method as claimed in claim 6, further comprising:
using an extended Kalman filter (EKF) to process the coordinate information and the rotation angle information.

8. The control method as claimed in claim 7, further comprising:
generating virtual reality (VR) image information according to the coordinate information and the rotation angle information which have the same timestamp.

9. A non-transitory computer-readable medium storing a computer program product operable to cause a head-mounted display (HMD) device to perform operations comprising:
generating a clock signal;
detecting coordinate information of a user;
detecting rotation angle information of the user; and
adding a timestamp to the coordinate information and the rotation angle information according to the clock signal;
wherein the coordinate information comprises an X-axis coordinate, a Y-axis coordinate, and a Z-axis coordinate of the user, and wherein the rotation angle information comprises a zenith angle rotation and an azimuth angle rotation of the user.
